(19) United States
(12) Patent Application Publication
(10) Pub. No.: US 2026/0055662 A1
(43) Pub. Date: Feb. 26, 2026

(54) STEPLADDER WITH LOWER BASE, UPPER BASE AND SAFETY CLIP

(71) Applicant: Cuprum SA de CV, San Nicolás de los Garza (MX)

(72) Inventors: Francisco Abraham VELAZQUEZ GARCIA, San Nicolas de los Garza (MX); Daniel Ivan PUENTE MEDINA, San Nicolas de los Garza (MX)

(21) Appl. No.: 18/978,801

(22) Filed: Dec. 12, 2024

(30) Foreign Application Priority Data
Aug. 26, 2024 (MX) MX/U/2024/000360

(51) Int. Cl. E06C 7/42; E06C 1/18; E06C 1/393

(52) U.S. Cl. CPC E06C 7/42; E06C 1/18; E06C 1/393

(57) ABSTRACT

Stepladder with lower base, upper base and safety clip, which is composed of two main bodies that we will call body of rungs and complementary body, with long and short lower bases, with curved shape and rough surface, and with an upper base, which in one of its edges has a “V” type break with a safety clip, with a hinge type joint element, which allows us to use the ladder in open use position and closed use position and which also has an additional support, and also has long reinforcement elements and short reinforcement elements that together allow us to have a solid and robust ladder.

### CROSS-REFERENCE TO RELATED APPLICATIONS

Not applicable.

### BACKGROUND OF THE INVENTION

The lower and upper bases of a ladder and the safety clip on stepladders are designed to provide an additional feature of utility and safety in the use of a ladder to assist users with the tasks to be performed. The lower base of the ladder with its curved design is intended to adapt properly and safely to any type of surface where it is used. The upper base of the ladder is an alternative design that allows us to accommodate and provide easy access to the tools and products that the user is using while on the ladder, also has on one of its sides with a “V” shaped spring, this spring allows us to place and use the ladder in its closed position of use, on an irregular surface safely, which represents a technical advantage and an innovative addition to the ladder is the incorporation of a safety clip which allows us to safely use the ladder in the closed position of use.

### SUMMARY OF THE INVENTION

The present invention refers to a stepladder with a lower base, upper base and safety clip that allow its portability, safe use and optimal storage;

Since the lower base with its curved finish allows us to safely place the ladder on an irregular surface, in addition the upper base has a geometric finish on which we can place tools or various products that the user is using and that has in one of its edges with a “V” type seal that adapts safely to various surfaces when we are using it and also has a safety clip that optimizes its storage and safe use, which allows us to have a more versatile, safer and more useful ladder.

### BRIEF DESCRIPTION OF DRAWINGS

FIG. 1 shows an isometric view of the ladder with the lower bases, the upper base, and the safety clip.

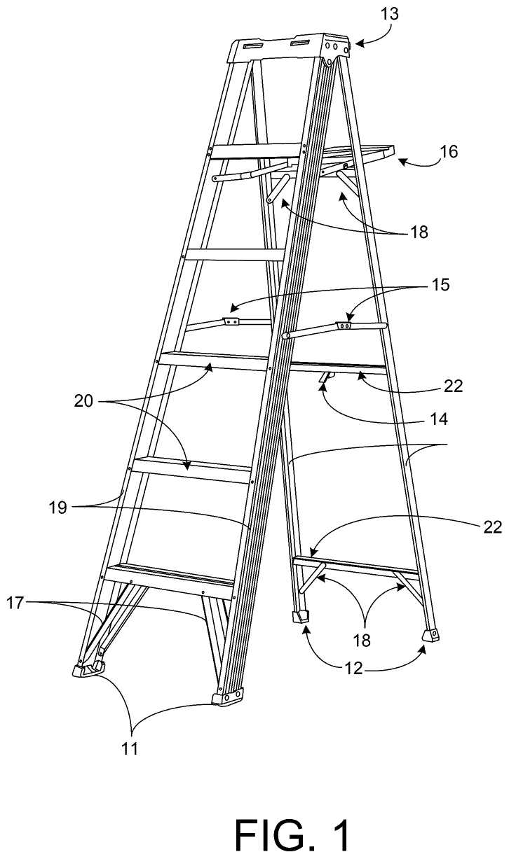

FIG. 2 shows an isometric view of the bottom base of the ladder.

FIG. 3 shows an isometric view of the top base of the ladder.

FIG. 4 shows an isometric view of the safety clip of the ladder.

### DETAILED DESCRIPTION OF THE INVENTION

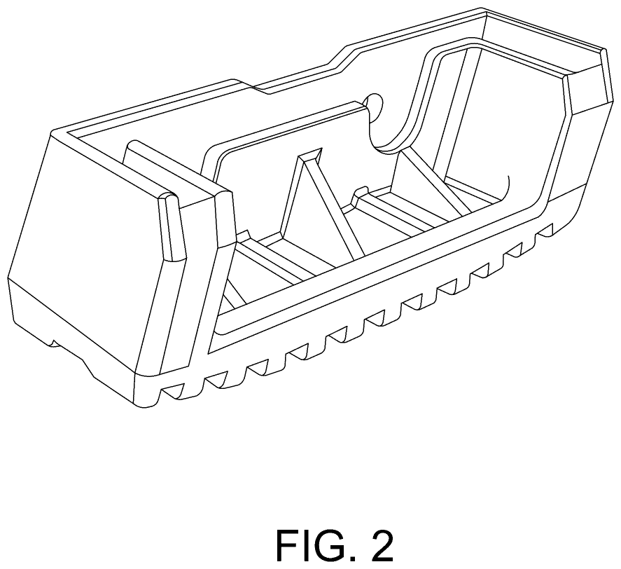

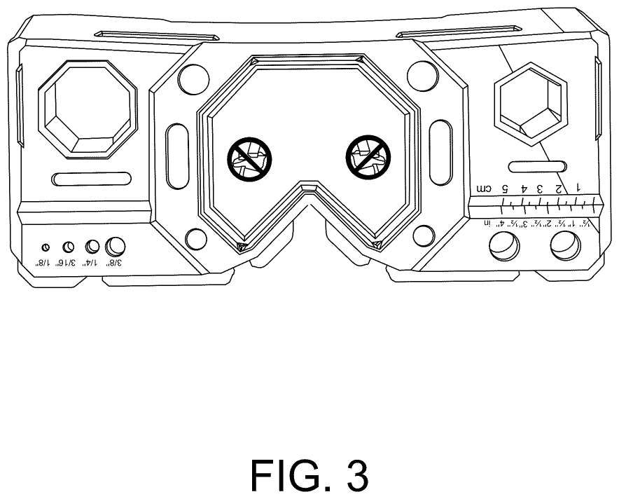

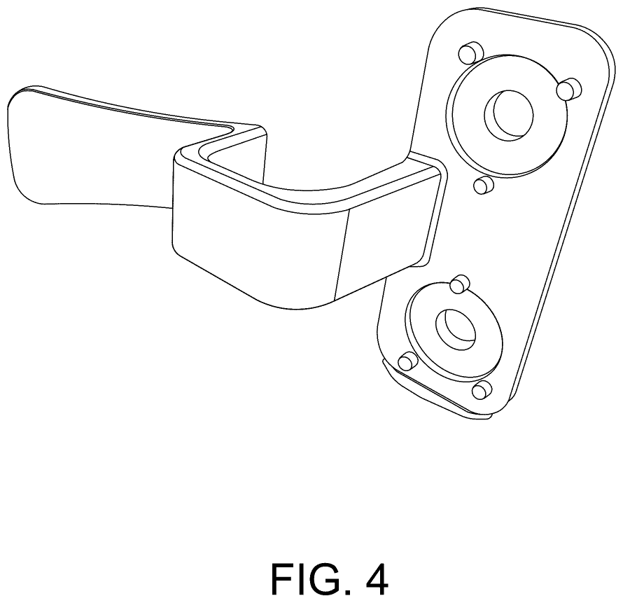

The stepladder with lower base, upper base and safety clip, consisting of two main bodies that we will call rungs body and complementary body, with long (11) and short (12) lower bases, with an upper base (13), with a safety clip (14), with a hinge-type connecting element (15), which allow us to use the ladder in open use position and closed use position and which also has an additional support (16), and also has long reinforcement elements (17) and short reinforcement elements (18) which together allow us to have a solid and robust ladder; detailing the body of rungs, which is formed with two vertical posts (19) and a plurality of rungs (20), preferably five rungs evenly distributed, which are fixed to the posts by means of fastening means, furthermore they have at least four long reinforcing elements (17), between their lower end and the lower rung, The long lower bases (11), which have a curved shape and a rough finish that allows them to settle securely on any type of surface, are inserted at their lower ends and fixed by means of fasteners, and the upper base (13) is assembled at their upper end, joined by fastening means, in addition the body of steps is joined to the complementary body in its central part with hinge-type joining elements (15), both bodies joined by fastening means, these allow the ladder to be used in an open use position and a closed use position, detailing the complementary body, which is formed with two vertical posts (21), and a plurality of crossbeams (22), preferably three uniformly distributed crossbeams, which are fixed to the posts by fastening means, and also have at least two short reinforcing elements (18), between their lower end and the lower crossbeam, and two other short elements below the upper crossbeam, joined by fastening means, also has on the upper crossbeam with an additional support (16), mounted on a hinge type element, which allows a greater area available for placing tools and/or products that the user is using, when working on the ladder, while at their lower ends they are inserted and fixed by securing means the short lower bases (12), which have a curved shape and a rough finish that allows it to settle safely on any type of surface, in addition at its upper end the upper base (13) is assembled, also in the central crossbeam is assembled and fixed by securing means the safety clip (14), which allows us to secure the ladder in the closed use position. In this way a compact, robust and secure ladder is available. Detailing the long and short lower bases, its design is seen in FIG. 2, these have a curved design and a rough finish making it possible to properly seat on any surface where the ladder is placed to be used. Detailing the upper base, its design can be seen in FIG. 3, this design shows a plurality of housings in various ways that allow us to store elements and tools that the user is using when working on the ladder, it is important to highlight the shape in the “V” shape at one of its edges, which will allow the ladder to be placed in working position on a corner, or on a post or on an irregular surface. Detailing the safety clip, its design can be seen in FIG. 4, in which the two holes are highlighted for assembly to the intermediate crossbeam and a robust latch body for safe use.

To properly use the stepladder with lower base, upper base and safety clip taking advantage of its innovative advantages, its use can consider an open use position and a closed use position, in the latter position with the certainty of the use of the safety clip, moreover it is feasible to place it on any type of surface due to the characteristics of its lower bases and due to the design of the upper base the position of the ladder can be placed in a versatile way on a corner or on a pole or on an irregular surface.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. The invention relates to a stepladder with a lower base, an upper base and a safety clip. The ladder is characterized in that it comprises two main bodies, which are referred to as a body of steps and a complementary body, with long and short lower bases, with an upper base, with a safety clip, with a hinge-type joining element, which allow the ladder to be used in the open use position and the closed use position and which also carries an additional support, and also has long reinforcement elements and with short reinforcement elements which, together, allow a solid and robust ladder.

2. Stepladder with lower base, upper base and safety clip, according to claim 1, characterized in that the body of rungs is formed by two vertical posts and a plurality of rungs, preferably five rungs evenly distributed, which are fixed to the posts by means of fastening means, furthermore they have at least four long reinforcing elements, between their lower end and the lower step, joined by means of fastening means, while at their lower ends are inserted and fixed by means of fastening means the long lower bases, these have a curved shape and a rough finish that allows them to sit securely on any type of surface, in addition, at the upper end is assembled the upper base, joined by means of fastening, in addition the body of rungs is attached to the complementary body in its central part with hinge-type connecting elements, both bodies joined by means of fastening, these allow us to use the ladder in an open position of use and a closed position of use.

3. Stepladder with lower base, upper base and safety clip, according to claim 1, characterized in that the complementary body is formed with two vertical posts, and a plurality of crosspieces, preferably three crossbeams evenly distributed, which are fixed to the posts by means of fastening means, in addition, there are at least two short reinforcing elements between the lower end and the lower cross member, and two other short elements below the upper cross member, joined by means of fasteners, and there is also an additional support on the upper cross member, mounted on a hinge-type element, This allows a larger available area to place tools and/or products that the user is using, when working on the ladder, while at its lower ends are inserted and fixed by means of fastening the short lower bases, which have a curved shape and a rough finish that allows to settle safely on any type of surface, also at its upper end is assembled the upper base, also in the central crossbeam is assembled and fixed by means of fastening the safety clip that allows the safe use of the ladder in the closed position of use. In this way we have available a compact, robust and safe ladder.

4. Stepladder with lower base, upper base and safety clip, according to claim 1, characterized in that the long and short lower bases have a curved design and a rough finish, which allows it to settle properly to any surface where the ladder is placed to be used.

5. Stepladder with lower base, upper base and safety clip, according to claim 1, characterized in that the upper base is made up of a design with a plurality of housings of various shapes that allow us to store elements and/or tools that the user is using when working on the ladder, it is important to highlight the “V” shape on one of its edges, which will allow us to place the ladder in working position on a corner, or on a pole or on an irregular surface.

6. Stepladder with lower base, upper base and safety clip, according to claim 1, characterized in that the safety clip has a design with two holes for its assembly to the intermediate crossbeam and a robust hooking body for its safe use.

7. Stepladder with lower base, upper base and safety clip, according to claim 1, characterized because it is composed of innovative advantages and for its use it can consider an open use position and a closed use position, in this last position with the certainty of the use of the safety clip, moreover it is feasible to place it on any type of surface by the characteristics of its lower bases and by the design of the upper base the position of the ladder can be placed in a versatile way, on a corner or on a post or on an irregular surface.
